(19) United States
(12) Patent Application Publication
(10) Pub. No.: US 2017/0167629 A1
(43) Pub. Date: Jun. 15, 2017

(54) PRESSURIZED VALVE DISENGAGEMENT SAFETY BAND DEVICE

(71) Applicant: Wayne Hodge, Custer, SD (US)

(72) Inventor: Wayne Hodge, Custer, SD (US)

(21) Appl. No.: 14/966,340

(22) Filed: Dec. 11, 2015

(51) Int. Cl. F16K 37/00; F16B 2/08; A44B 17/00; G09F 3/14; F16B 1/00

(52) U.S. Cl. CPC F16K 37/0008; G09F 3/14; F16B 1/00; A44B 17/0023; F16B 2/08; F16B 2001/0028

(57) ABSTRACT

A pressurized valve disengagement safety band device enhances safety when disengaging a pressurized valve connection. The device absorbs and directs contents of a pressurized tank away from a person when the person disengages a fill line from a fill valve of a pressurized tank. The device includes a band having an outer face, an inner face, and a peripheral edge extending around the outer face and the inner face. A coupler is coupled to the band wherein the band is coupleable to itself forming a loop configured for positioning around a pressurized valve connection.

### BACKGROUND OF THE DISCLOSURE

### Field of the Disclosure

The disclosure relates to band devices and more particularly pertains to a new band device for enhancing safety when disengaging a pressurized valve connection by absorbing and directing contents of a pressurized tank away from a person when the person disengages a fill line from the pressurized tank.

### SUMMARY OF THE DISCLOSURE

An embodiment of the disclosure meets the needs presented above by generally comprising a band having an outer face, an inner face, and a peripheral edge extending around the outer face and the inner face. A coupler is coupled to the band wherein the band is coupleable to itself forming a loop configured for positioning around a pressurized valve connection.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a bottom front side perspective view of a pressurized valve disengagement safety band device according to an embodiment of the disclosure.

FIG. 2 is a rear view of an embodiment of the disclosure.

FIG. 3 is a perspective view of an embodiment of the disclosure in an opened position in use.

FIG. 4 is a perspective view of an embodiment of the disclosure in use.

FIG. 5 is a perspective view of an embodiment of the disclosure in a storage position.

FIG. 6 is a cross-sectional view of an embodiment of the disclosure taken along line 6-6 of FIG. 2.

### DESCRIPTION OF THE PREFERRED EMBODIMENT

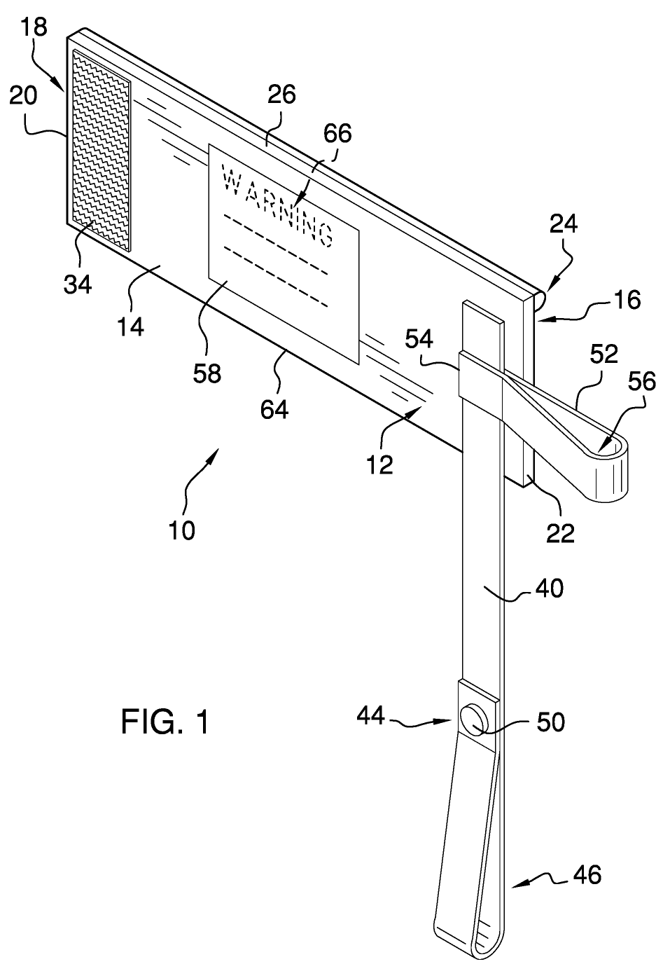

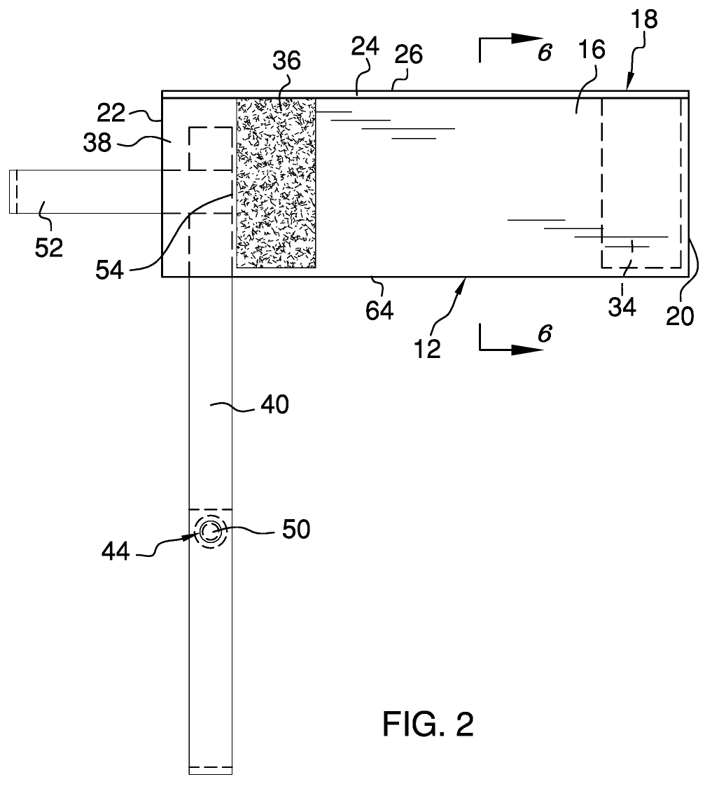

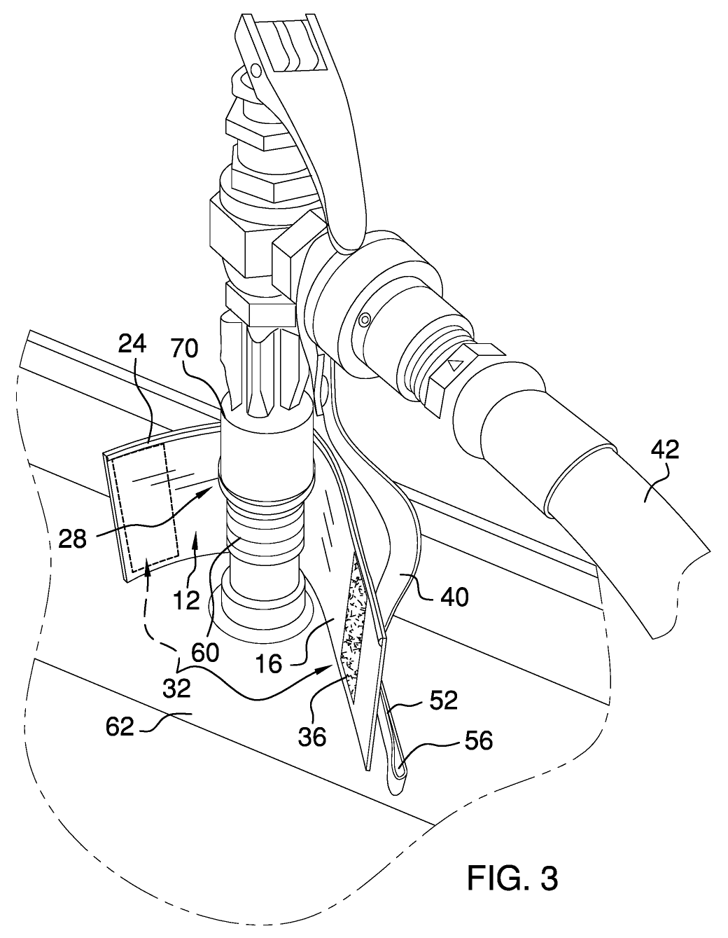

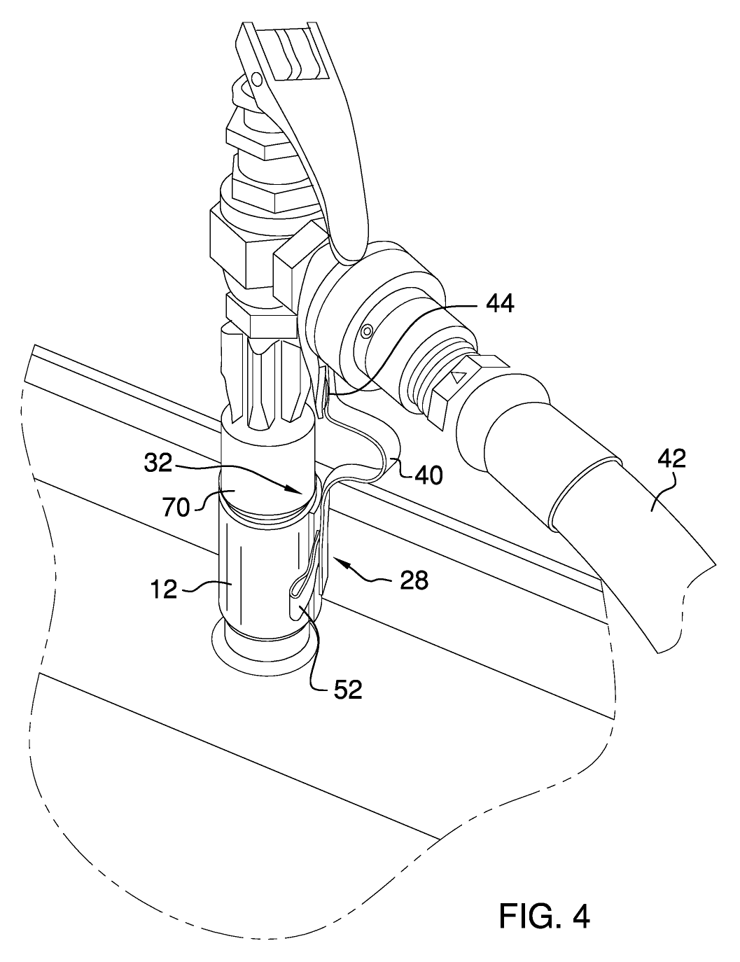

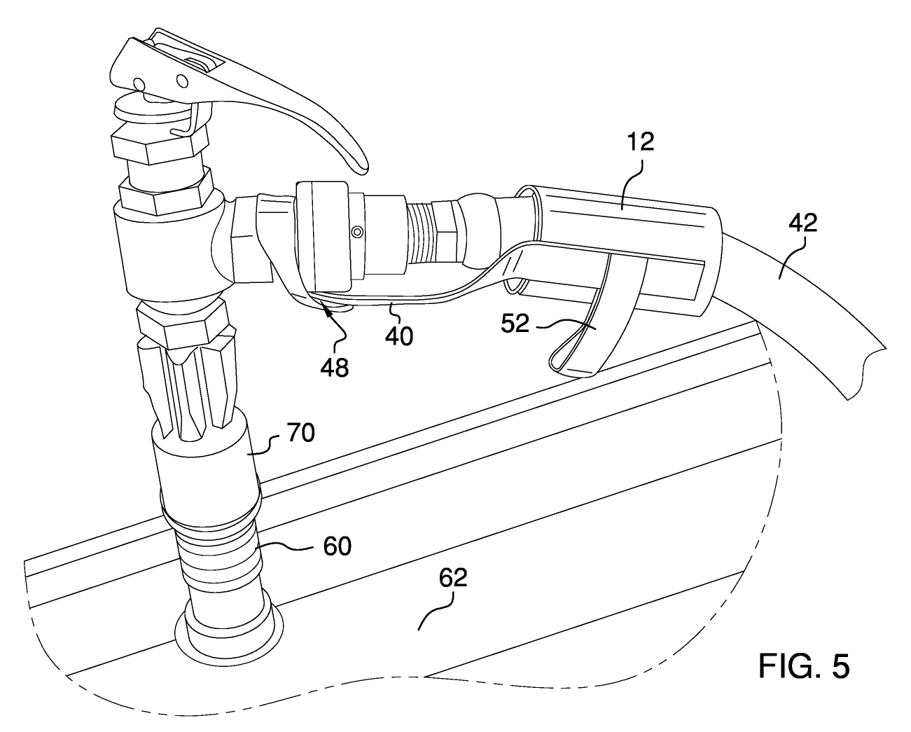

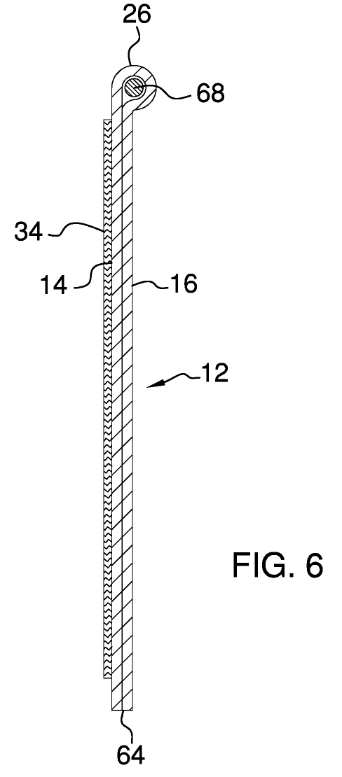

With reference now to the drawings, and in particular to FIGS. 1 through 6 thereof, a new band device embodying the principles and concepts of an embodiment of the disclosure and generally designated by the reference numeral 10 will be described.

As best illustrated in FIGS. 1 through 6, the pressurized valve disengagement safety band device 10 generally comprises a band 12 having an outer face 14, an inner face 16, and a peripheral edge 18 extending around the outer face 14 and the inner face 16. The band 12 has a first end 20 and a second end 22. A protrusion 24 extends from the inner face 16 of the band 12. The protrusion 24 is elongated and extends along an upper section 26 of the peripheral edge 18 of the band 12. The protrusion 24 may extend a full length between the first end 20 and the second end 22 or an effective length along the band 12 such that the protrusion 24 forms a seal above a pressurized valve connection 28 when the band 12 is formed into a loop 30 extending fully around the pressurized valve connection 28. The band 12 may be constructed of a flexible and durable material such as nylon or the like. Thus, when the pressurized valve connection 28 is disconnected, the band 12 absorbs and directs away from the user any matter released under pressure as the pressurized valve connection 28 is disconnected. The protrusion 24 may be formed by overlapping the material of the band 12 over a spline 68. The spline 68 may be secured in place using stitching or another conventional method.

A coupler 32 is coupled to the band 12 wherein the band 12 is coupleable to itself forming and holding the band 12 in the loop 30 around the pressurized valve connection 28. The coupler 32 may be a first portion of hook and loop fastener 34 coupled to the outer face 14 and a second portion of hook and loop fastener 36 coupled to the inner face 16. The first portion of hook and loop fastener 34 is complementary to the second portion of hook and loop fastener 36 wherein the band 12 is configured for being wrapped around the pressurized valve connection 28. The widths of the first portion of hook and loop fastener 34 and the second portion of hook and loop fastener 36 are such that the band 12 may be snugly fit over conventional or standard sized valve connections. The first portion of hook and loop fastener 34 is positioned adjacent to the first end 20 of the band 12. The second portion of hook and loop fastener 36 is positioned offset from the second end 22 of the band 12 defining a tab portion 38 of the band 12 extending between the second end 22 of the band 12 and the second portion of hook and loop fastener 36. The first portion of hook and loop fastener 34 is a hook portion and the second portion of hook and loop fastener is a loop portion such that the more abrasive hook portion will be facing away from the pressurized valve connection 28 during use.

A connection strap 40 is coupled to the band 12. The connection strap 40 extends outwardly from the band 12 and may extend outwardly from a longitudinal edge of the band 12. The connection strap 40 is configured for coupling the band 12 to a fill hose 42 used in the pressurized valve connection 28. Thus, the band 12 is tethered to and retained with the fill hose 42 to be readily accessible during use of the fill hose 42 to fill different pressurized tanks. A fastener 44 is coupled to the connection strap 40 such that a distal portion 46 of the connection strap 40 is formable into a ring 48 configured for extending around the fill hose 42. The fastener 44 may be a snap fastener 50.

A release strap 52 may be coupled to the band 12. The release strap 52 extends from the second end 22 of the band 12 facilitating disengagement of the coupler 32 after disconnection of the pressurized valve connection 28. The release strap 52 is parallel to a longitudinal axis of the band 12 and extends from the tab portion 38. The release strap 52 may have opposite ends 54 coupled to the band 12 defining a loophole 56 facilitating grasping and manipulation of the release strap 52 while wearing protective gloves. Each of the connection strap 40 and the release strap 52 may be coupled to the band 12 using reinforced stitching. The connection strap 40 and release strap 52 may be constructed of webbing using a conventional material. The release strap 52 may be offset relative to a central longitudinal axis of the band 12 such that the release strap is positioned closer to a bottom section 64 of the peripheral edge 18 than the upper section 26 of the peripheral edge 18. The peripheral edge 18 may have a height between 4 and 5 inches and a length between 10 and 12 inches. The thickness of the band 12 exclusive of the protrusion 24 may be between 1/32 and ⅛ inches. The second portion of hook and loop fastener 36 may be offset from the second end 22 between 0.75 and 1.25 inches.

A warning patch 58 may be coupled to the outer face 14 of the band 12 to include indicia 66. The indicia 66 may be instructions for use, a logo, a warning, or the like.

In use, the band 12 is coupled to the fill hose 42 using connection strap 40. The band 12 is then readily available when the fill hose 42 is to be disconnected from a fill valve 60 of a pressurized tank 62. The band 12 is wrapped around the pressurized valve connection 28 positioning the protrusion 24 to engage a connector 70 of the fill hose 42 and the band 12 extending over the pressurized valve connection 28. The fill hose 42 is then disconnected from the fill valve 60 by grasping and rotating the band 12 and connector 70 of the fill hose 42. When pressurized contents are expelled as the fill hose 42 is disconnected from the fill valve 60, the seal formed by the protrusion 24 and the band 12 absorb and direct the force and contents away from the user outwardly from the bottom section 64 of the peripheral edge 18 of the band 12. After disconnection, the band 12 is released from the connector 70 of the fill hose 42 by grasping one of both of the tab portion 44 and the release strap 52 to disengage the coupler 32.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pressurized valve disengagement safety band device comprising:
a band having an outer face, an inner face, and a peripheral edge extending around said outer face and said inner face; and
a coupler coupled to said band wherein said band is coupleable to itself forming a loop configured for positioning around a pressurized valve connection.

2. The device of claim 1, further comprising said coupler a first portion of hook and loop fastener being coupled to said outer face and a second portion of hook and loop fastener being coupled to said inner face, said first portion of hook and loop fastener being complementary to said second portion of hook and loop fastener wherein said band is configured for being wrapped around the pressurized valve connection.

3. The device of claim 2, further comprising said first portion of hook and loop fastener being positioned adjacent to a first end of said band.

4. The device of claim 3, further comprising said second portion of hook and loop fastener being positioned offset from a second end of said band defining a tab portion of said band extending between said second end of said band and said second portion of hook and loop fastener.

5. The device of claim 2, further comprising said first portion of hook and loop fastener being a hook portion and said second portion of hook and loop fastener being a loop portion.

6. The device of claim 1, further comprising a connection strap coupled to said band, said connection strap extending outwardly from said band wherein said connection strap is configured for coupling said band to a fill hose.

7. The device of claim 6, further comprising a fastener coupled to said connection strap such that a distal portion of said connection strap is formable into a ring configured for extending around the fill hose.

8. The device of claim 7, further comprising said fastener being a snap fastener.

9. The device of claim 1, further comprising:
said band having a first end and a second end; and
a release strap coupled to said band, said release strap extending from said second end of said band.

10. The device of claim 9, further comprising said release strap being parallel to a longitudinal axis of said band.

11. The device of claim 1, further comprising a protrusion extending from said inner face of said band, said protrusion being elongated and extending along an upper section of said peripheral edge of said band.

12. A pressurized valve disengagement safety band device comprising:
a band having an outer face, an inner face, and a peripheral edge extending around said outer face and said inner face, said band having a first end and a second end;
a protrusion extending from said inner face of said band, said protrusion being elongated and extending along an upper section of said peripheral edge of said band;
a coupler coupled to said band wherein said band is coupleable to itself forming a loop configured for positioning around a pressurized valve connection, said coupler including a first portion of hook and loop fastener being coupled to said outer face and a second portion of hook and loop fastener being coupled to said inner face, said first portion of hook and loop fastener being complementary to said second portion of hook and loop fastener wherein said band is configured for being wrapped around the pressurized valve connection, said first portion of hook and loop fastener being positioned adjacent to a first end of said band, said second portion of hook and loop fastener being positioned offset from a second end of said band defining a tab portion of said band extending between said second end of said band and said second portion of hook and loop fastener, said first portion of hook and loop fastener being a hook portion and said second portion of hook and loop fastener being a loop portion;
a connection strap coupled to said band, said connection strap extending outwardly from said band wherein said connection strap is configured for coupling said band to a fill hose;
a fastener coupled to said connection strap such that a distal portion of said connection strap is formable into a ring configured for extending around the fill hose, said fastener being a snap fastener; and
a release strap coupled to said band, said release strap extending from said second end of said band, said release strap being parallel to a longitudinal axis of said band.
